(19) United States
(12) Patent Application Publication
(10) Pub. No.: US 2012/0286552 A1
(43) Pub. Date: Nov. 15, 2012

(54) WHEELCHAIR SEAT ASSEMBLY

(76) Inventors: MARTIN KACE, New York, NY (US); MAGNUS LUNDSTROM, New York, NY (US)

(21) Appl. No.: 13/104,983

(22) Filed: May 11, 2011

(51) Int. Cl. A61G 5/10; A47C 1/00; A47C 3/00; A47C 7/02; A47C 7/14

(52) U.S. Cl. 297/284.2; 297/452.1; 297/452.48; 297/452.4

(57) ABSTRACT

A seat assembly includes a frame supporting an elastomeric seating surface such that there are no rigid points of contact at the front and rear regions of the seating surface. Tension across the front and rear regions of the seating surface are independently adjustable by altering the front and rear widths of the frame. The frame widths are adjusted by rotating front and rear threaded frame members.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO COMPACT DISC APPENDIX

Not applicable.

### BACKGROUND OF INVENTION

1. Field of the Invention

The present invention relates generally to seat assemblies and more particularly to seat assemblies for use with wheelchairs.

2. Background of the Related Art

Individuals who must remain seated for prolonged periods of time confront a myriad of problems. One significant concern is the development of pressure sores. Pressure sores, also referred to as contact necrosis, are a painful affliction that develop rapidly in response to various factors, including restricted blood flow due to lack of physical movement and sustained moisture due to insufficient circulation of air around the body surfaces that remain in contact with the seating surface. In particular, wheelchair users and their caregivers must remain vigilant in their efforts to avoid the development of pressure sores. When these sores do develop, the affliction must be treated promptly for fear that it may become exacerbated.

One conventional method for reducing or preventing the development of pressure sores is the use of seating cushions composed of various materials, including foam, gel, fluid and thixotropic materials. Seat cushions are intended to alleviate the pressure loads endured by sensitive areas of the skin while maintaining support at surfaces less likely to develop pressure sores. While these solutions offer varying degrees of success in alleviating the pressure load on sensitive areas of the skin, they invariably have several disadvantages. These disadvantages include insufficient weight distribution, poor shear and tension properties, inconsistent weight distribution between uses, and discouraging good seating posture.

Furthermore, the cushion solution does nothing to address, and even exacerbates, the retention of moisture on skin surfaces. Typically, the materials within and surrounding a cushion are not breathable. As they tend to conform to the body surfaces they support, they actually increase the skin surface area that remains in constant contact with the seating surface. As a result, moisture from natural perspiration and any other sources develops more quickly and natural evaporation of this moisture is inhibited when individuals sit on a cushion for any duration.

Another problem encountered with the use of seat cushions is the addition of significant bulk and weight to wheelchairs. Increased volume makes disassembly and transport of wheelchairs much more cumbersome task. Similarly, added weight significantly impairs the mobility of all wheelchair-bound individuals. This is especially true for individuals with decreased upper body strength and self-propelled wheelchairs.

Further, these cushion solutions do not address another significant concern surrounding long term use of wheelchair seats. Seating surfaces must be cleaned regularly to maintain adequate levels of hygiene. They must be cleaned promptly if soiled due to incidents of incontinence or in the course of normal use. In addition, prolonged contact with seating surfaces leads to the accumulation of residue that is unsanitary and can become an irritant. The components of seat cushions, such as foams and cloth covers, are often absorptive, making them very difficult to keep clean using conventional cleansing methods. When seat cushions do become soiled, it may be impractical to clean them, thus requiring costly replacement.

Another strategy for avoiding the development of pressure sores is the use of segmented and articulating seats that incorporate mechanical or pneumatic apparatuses into the seating assembly. Such apparatuses relieve pressure by selectively withdrawing portions of the seat from contact with the seated wheelchair occupant. A related strategy uses pneumatic or hydraulic systems to adjust cushion pressure. Both of these solutions have several disadvantages. The incorporation of such an apparatus significantly increases the weight of the wheelchair. This is especially important where the wheelchair is self-propelled or the occupant has impaired upper body strength. Further, such apparatuses necessarily increase the cost of the wheelchair, require significant maintenance beyond that already required for a wheelchair and introduce an additional opportunity for mechanical failure. These are all practical considerations for individuals already faced with significant healthcare costs. Finally, this approach does not decrease the retention of moisture, nor does it improve the ease of maintaining the seating surface in a hygienic state.

Another approach to wheelchair seats uses a seating surface formed by a latticework of spaced inelastic straps attached to each other or to the support rails of the wheelchair itself. This solution attempts to address the problem of moisture retention by increasing the opportunity for the circulation of air at the seating surface. While air circulation may be increased, the straps at the periphery of the seating surface as well as the wheelchair rails used to support the latticework create hard edges at the forward, rear and side regions of the seating surface. Significant pressure points occur where the wheelchair user's body comes into contact with these hard edges. The circulation of blood at these points is restricted or prevented entirely causing additional damage at these points and in more distant parts of the body supplied with blood through these regions.

Every attempt to address the development of pressure sores in wheelchair seats suffers from a number of disadvantages. Accordingly, it remains desirable to provide a seat assembly that discourages the development of pressure sores while eliminating the disadvantages encountered by previous designs.

Another significant problem encountered by users of wheelchairs is the need for a suspension system. Traditionally, suspension systems are used in wheeled vehicles to improve handling and to isolate occupants from injury or discomfort from bumps and vibration while traversing uneven surfaces. This same benefit could be realized in a wheelchair. Previous attempts to address the need for suspension have borrowed from the automotive and bicycle industries. These solution involved the incorporation of additional components to a wheelchair, such as coils, shocks or cushioned inserts. All of these attempts necessarily add additional weight to the wheelchair, which is a significant disadvantage in self-propelled wheelchairs and for individuals with decreased upper-body strength. Accordingly, it remains desirable to provide a solution that provides a system of suspension for wheelchairs without increasing the weight of the wheelchair itself.

It is, therefore, an object of this invention to provide a wheelchair seat which discourages the development of pressure sores. Another object of this invention is to provide a wheelchair seat which allows pressure to be more evenly distributed across its seating surface. A further object of this invention is to provide a wheelchair seat which can be adjusted to suit individual occupants' preferences and needs. Still another object of this invention is to provide a wheelchair seat that facilitates the circulation of moisture and air surrounding the seating surface. An additional object of this invention is to provide a wheelchair seat that encourages the circulation of blood where a wheelchair user's bodies meets the seating surface. A further object of this invention is to provide a wheelchair seat which is easily sanitized to maintain hygiene. It is also an object of this invention to provide a wheelchair seat that does not significantly contribute to the weight of a wheelchair. Another object of this invention is to provide a wheelchair seat which does not discourage or prevent the transportation of a wheelchair. An additional object of this invention is to provide a wheelchair seat that incorporates a system of suspension.

### SUMMARY OF INVENTION

Accordingly, the present invention contemplates a new and improved seat, and more particularly, a wheelchair seat assembly. The invention eliminates the above-discussed and other drawbacks of the currently employed wheelchair seating solutions.

The invention solves the problem of pressure sore development by providing a seating surface with improved and adjustable pressure distribution. The problem of heavy and cumbersome seat cushioning options is solved by providing a seat assembly that is both lightweight and sturdy. The invention solves the problem of ease of transporting a wheelchair seat by providing a seat assembly that is detachable from a wheelchair. The problem of maintaining hygienic standards is solved by providing a seating surface that is easily removed and cleaned.

In one embodiment, the invention provides a seating assembly with no rigid points of contact near the front and rear regions of the seating surface. In another embodiment of the invention, the seat assembly is provided with an elastomeric seating surface extending between side members of a frame that are situated higher than the front and rear members. In yet another embodiment of the invention, the side members of the frame are angled away from the plane formed by the front and rear members and the side members are curved away from the longitudinal axis of the assembly. In a further embodiment of the invention, the tension across the seating surface of the seating assembly can be altered by adjusting the width of the seating assembly. In still another embodiment of the invention, the tension across the seating surface of the seating assembly can be altered by independently adjusting the front and rear widths of the seating assembly.

### BRIEF DESCRIPTION OF DRAWINGS

The invention may take physical form in certain parts and arrangements of parts, a preferred embodiment of which will be described in detail in this specification. Other objects and advantages of the invention will become apparent upon reading the following detailed description and upon reference to the accompanying drawing, in which:

FIG. 1 is a front perspective view of the seat frame of a seating assembly constructed in accordance with the invention.

FIG. 2 is a top plan view of the seat frame of FIG. 1.

FIG. 2A is a sectional view of the seat frame along line A-A of FIG. 2 with seating surface attached.

FIG. 3A is a front view of the seat frame of FIG. 1.

FIG. 3B is a front view of the seat frame of FIG. 1.

FIG. 4 is a side view of the seat frame of FIG. 1.

FIG. 5 is an exploded view of yet another embodiment of the seat frame of a seating assembly constructed in accordance with the invention.

FIG. 6 is a front perspective view of a seating assembly constructed in accordance with the invention.

FIG. 7 is a front perspective view of another embodiment of the seat frame of a seating assembly constructed in accordance with the invention.

FIG. 8 is a front perspective view of yet another embodiment of the seat frame of a seating assembly constructed in accordance with the invention.

### DETAILED DESCRIPTION OF INVENTION

While the invention is susceptible to various modifications and alternative forms, specific embodiments thereof have been shown by way of example in the drawings that are herein described in detail. It should be understood, however, that the description herein to specific embodiments is not intended to limit the invention to the particular forms disclosed, but on the contrary, the intention is to cover all modifications, equivalents, and alternatives falling within the spirit and scope of the invention. It will of course be appreciated that in the development of any such actual embodiment, numerous decisions specific to any particular implementation must be made to achieve the developers' goals, such as compliance with regulatory and medical constraints, which will vary from one implementation to another. In the interest of clarity, not all features of an actual implementation are described in this specification. Moreover, it will be appreciated that such development effort might be complex and time-consuming, but would nevertheless be a routine undertaking for those of ordinary skill in the art having the benefit of this disclosure.

As used herein, rigid point of contact refers to the interface between any firm component of the invention and the user's body, such that increased levels of pressure would be exerted on the user's body at the interface. Such rigid points of contact are liable to promote the development of pressure sores and the myriad medical problems accompanying pressures sores.

As used herein, elastomeric refers to any material which, upon application of a force to its relaxed, initial length can stretch or elongate in at least one direction and will substantially recover back to approximately its original length upon release of the applied force.

The frame components discussed herein may be composed of any of a number of sufficiently strong materials and may be formed or constructed by any of a number of processes. Nothing in the descriptions of the embodiments below is intended to be a limitation in the possible materials to be used in constructing any form of this invention.

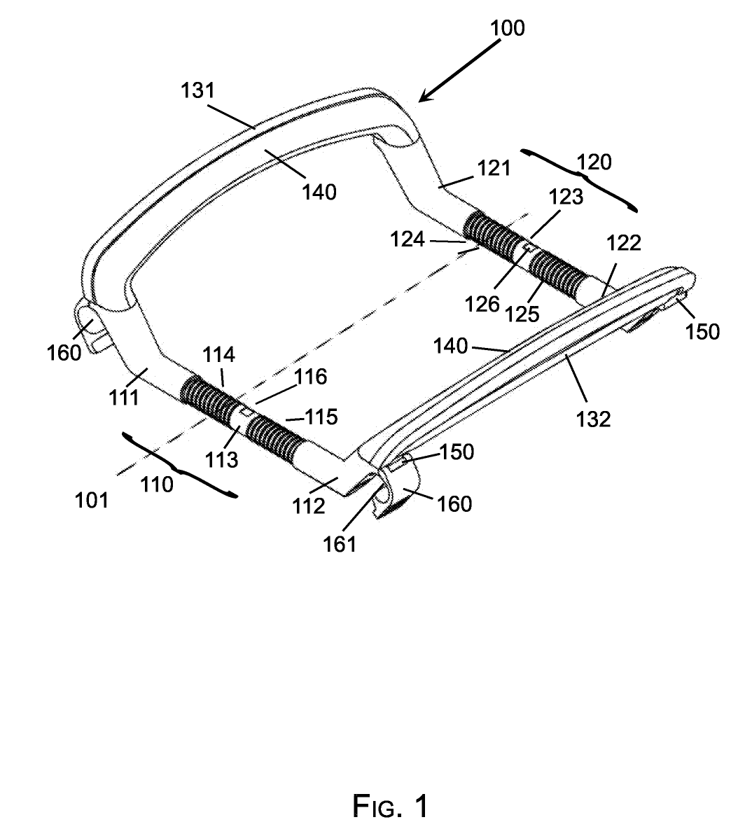

FIG. 1 is a front perspective view of an embodiment of a seat frame 100. Seat frame 100 has a longitudinal axis 101. The seat frame 100 includes a frame of a front member 110, a rear member 120, and side members 131 and 132. Front member 110 includes front end members 111 and 112 and a front threaded member 113. Front threaded member 113 has a central region 113 and threaded regions 114 and 115. The surface of central region 113 further includes one or more flattened regions 116. Threaded regions 114 and 115 are threaded in reverse orientation to each other.

Rotation of front threaded member 110 in one direction is a tightening rotation causing the front end members 111 and 112 to move closer together. Rotation of front threaded member 110 in the opposite direction is a loosening rotation causing the front end member 111 and 112 to move further apart. Flattened region 116 accepts use of a lever, such as a specialized key or standard wrench, to facilitate rotation of front threaded member 110.

Rotation of rear threaded member 120 in one direction is a tightening rotation causing the rear end members 121 and 122 to move closer together. Rotation of rear threaded member 120 in the opposite direction is a loosening rotation causing the rear end members 121 and 122 to move farther apart. Flattened region 126 accepts use of a lever, such as a specialized key or standard wrench, to facilitate rotation of rear threaded member 120.

Cushioning material 140 is layered across and secured to the inner peripheries and upper surfaces of side members 131 and 132. Flanges 150 project from seat frame 100. Clasps 160 are pivotally attached to seat frame 100. Seat frame 100 typically attaches to longitudinally oriented bars of a standard wheelchair frame. Such frame bars are oriented approximately parallel to longitudinal axis 101 and approximately perpendicular the front and rear members 110 and 120. Seat frame 100 is supported on wheelchair frame bars by flanges 150.

When a seating surface is attached to the seat frame, the only portion of the frame with which a seated user's body would come in contact with the frame is along the inner peripheries and upper surfaces of the side members 131 and 132. These are also the only firm edges which a user's body might encounter. The cushioning material 140 is present across the entirety of these surfaces to mitigate this contact and distribute any potential pressure points along this interface.

Seat frame 100 is secured to wheelchair frame bars by using clasps 160. Inner circumference of clasps (161) approximates the outer circumference of wheelchair frame bars. To secure seat frame 100, clasps 160 are pivoted down onto wheelchair frame bars and snapped into place around the wheelchair frame bars with the application of pressure. Seat frame 100 is held in place on wheelchair frame bars by the tension exerted around the frame bars at the inner circumference of clasps 161 and by the downward force exerted at flanges 150 by the weight of the user on seat frame 100.

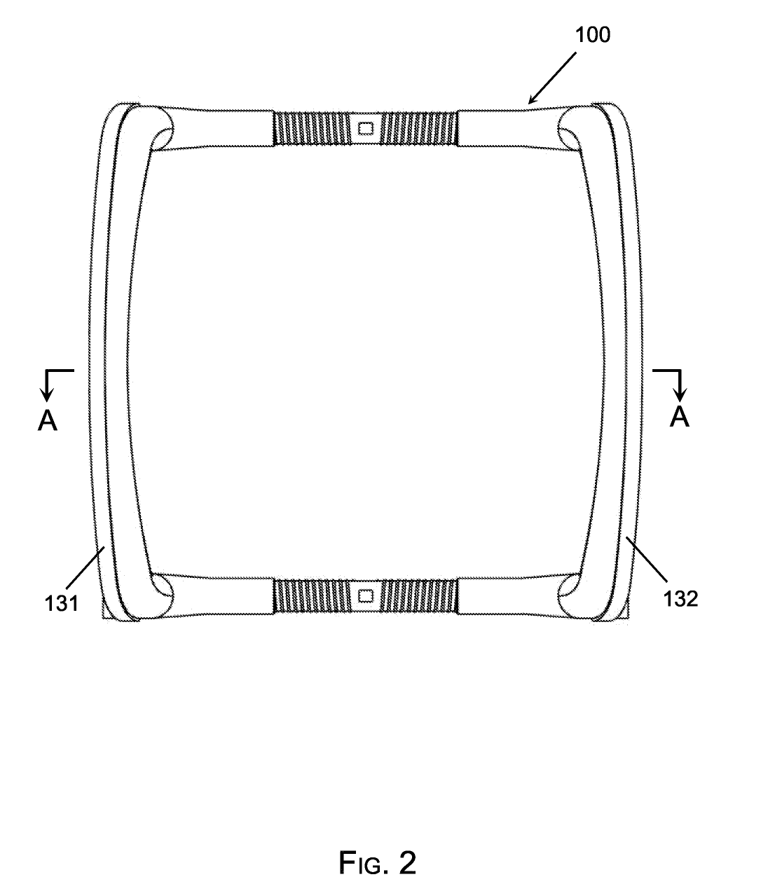

FIG. 2 is a top plan view of seat frame 100. In FIG. 2, the concavity of side members 131 and 132 is clearly indicated. Due to this concavity, the width of seat frame 100 varies from front to back. This variation in width corresponds to variation in tension across a seating surface extending between side members 131 and 132. Seating surface tension would be greatest where a seating surface is stretched across the widest part of seat frame 100; namely, the portions of a seating surface near the middle. Seating surface tension would be less where a seating surface is stretched across narrower parts of seat frame 100; namely, the front and rear of the such a seating surface. This configuration allows such a seating surface to firmly support the majority of a user's weight near the center of the seat. Reduced tension near the front and rear of the seating surface avoid the formation of a firm edge to the seating surface which would risk compromising a user's circulation and comfort near the front underside of a thigh or near the rear of the buttocks.

FIG. 2A is a sectional view of seat frame 100, taken along line A-A, with seating surface 160 attached. Seating surface 160 is stretched across cushioning layers 140. Seating surface 160 extends between side members 131 and 132 and is secured at channels 133 and 134.

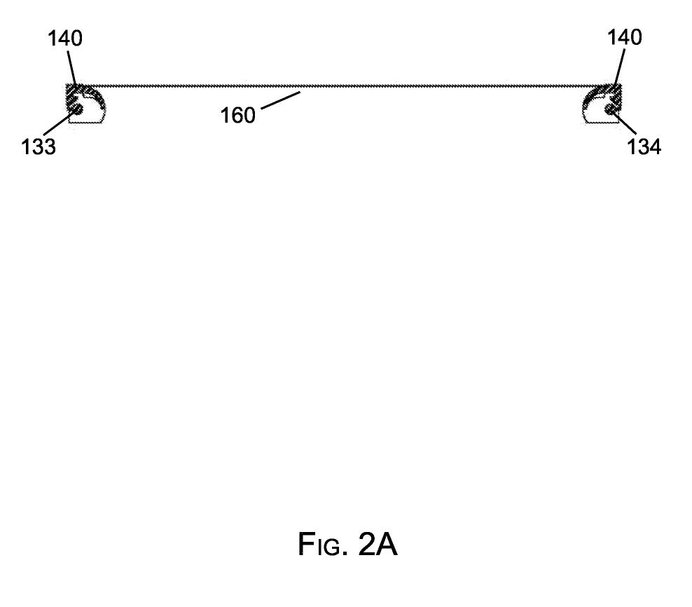

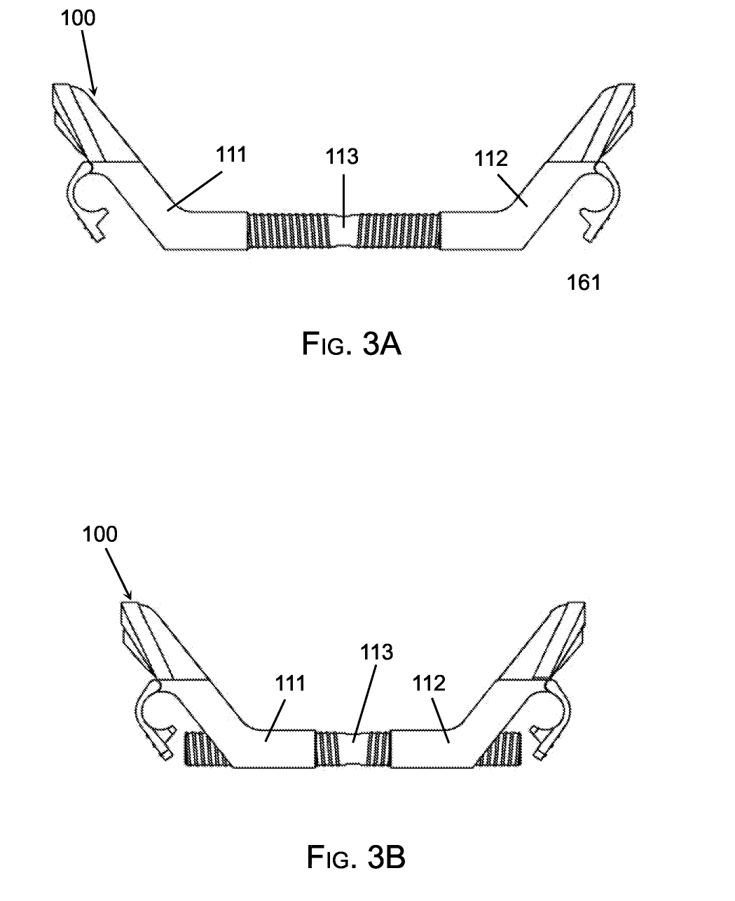

FIG. 3A is front view of seat frame 100. Front threaded member 113 has been rotated in a loosening rotation, causing front end members 111 and 112 to move farther apart. After such a rotation, the width of the front of seat frame 100 is wider.

FIG. 3B is front view of seat frame 100. Front threaded member 113 has been rotated in a tightening rotation, causing front end members 111 and 112 to move closer together. After such a rotation, the width of the front of seat frame 100 is wider. A seating surface attached to seat frame 100 adjusted according to FIG. 3A would experience greater stretch and thus greater tension than a seating surface attached to seat frame 100 adjusted according to FIG. 3B.

FIGS. 3A and 3B clearly indicate that side members 131 and 132 are angled away from the longitudinal axis of the seat frame 100. This angle is determined, in part, by the angle at which the side members are attached to front end members 111 and 112. In this embodiment, the angle is also determined by the angular shape of the end members. The distance between the tops of the side members, which corresponds to the width of a seating surface to be attached to the side members is wider than the distance between the clasps. As such, the seating surface width is not limited by the width of the wheelchair frame bars to which the seat assembly will be attached.

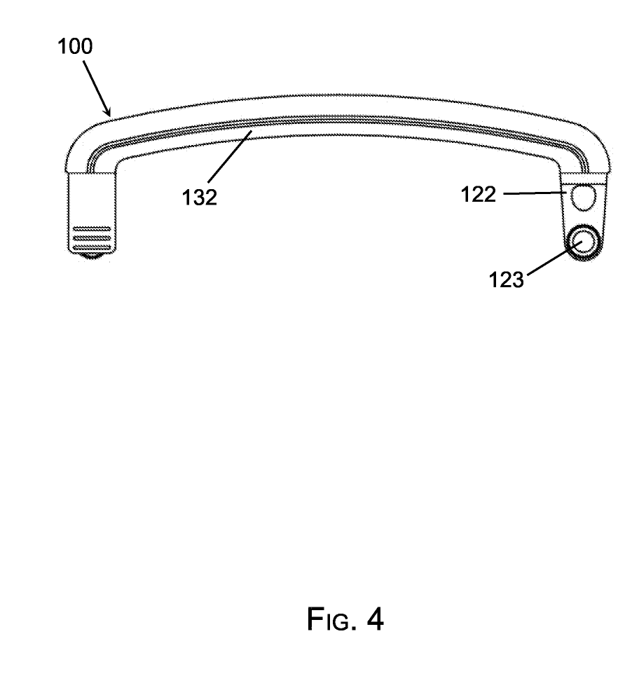

FIG. 4 is a side view of seat frame 100. In FIG. 4, the vertical concavity of side member 132 is visible. A seating surface attached to seat frame 100 would curve down at the front and rear edges. This curvature of the seating surface would avoid the formation of a firm edge at the front or rear of the seating surface and avoid compromising a user's circulation and comfort near the front underside of a thigh or near the rear of the buttocks.

As indicated in FIGS. 3A, 3B, and 4, the tops of the side members, which correspond to the height of a seating surface to be attached to the members, is relatively higher than the front and rear members. This arrangement avoids the presence of firm edges near the front or rear portions of the seating surface.

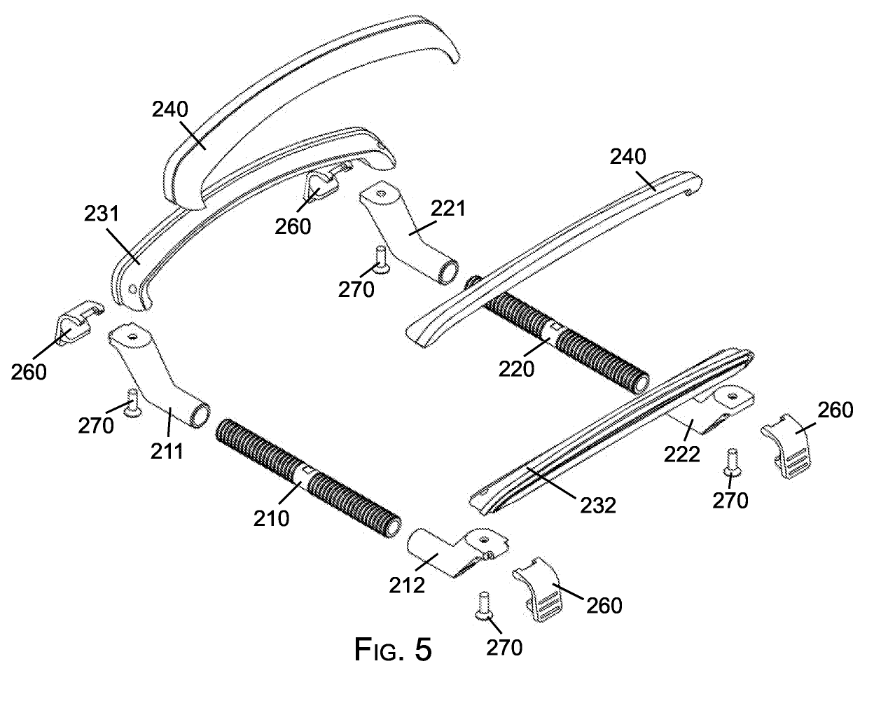

FIG. 5 is an exploded view of yet another embodiment of the seat frame. In this embodiment, clasps 260 are provided at four locations around seat frame 100. This arrangement permits the seating assembly to be secured to a wheelchair frame at four locations.

Side member 231 is pivotally attached to front end member 211 and rear end member 221 by fasteners 270. Side member 232 is pivotally attached to front end member 212 and rear end member 222 by fasteners 270. The ability of end members and side members to pivot relative to one another permits the distance between front end members and the distance between rear end members to be set independently. By rotating threaded members 210 and 220 separately, a user or an assistant would be able to customize the tension across the seating surface to the user's preferences.

For example, a user may prefer a very firm seating surface near the rear and a softer seating surface near the front. This could be accomplished by increasing the width across the rear members and decreasing the width across the front members. This variation in widths corresponds to variation in the degree to which different regions of a seating surface are stretched, in the amount of tension across seating surface regions, and the firmness experienced by the user.

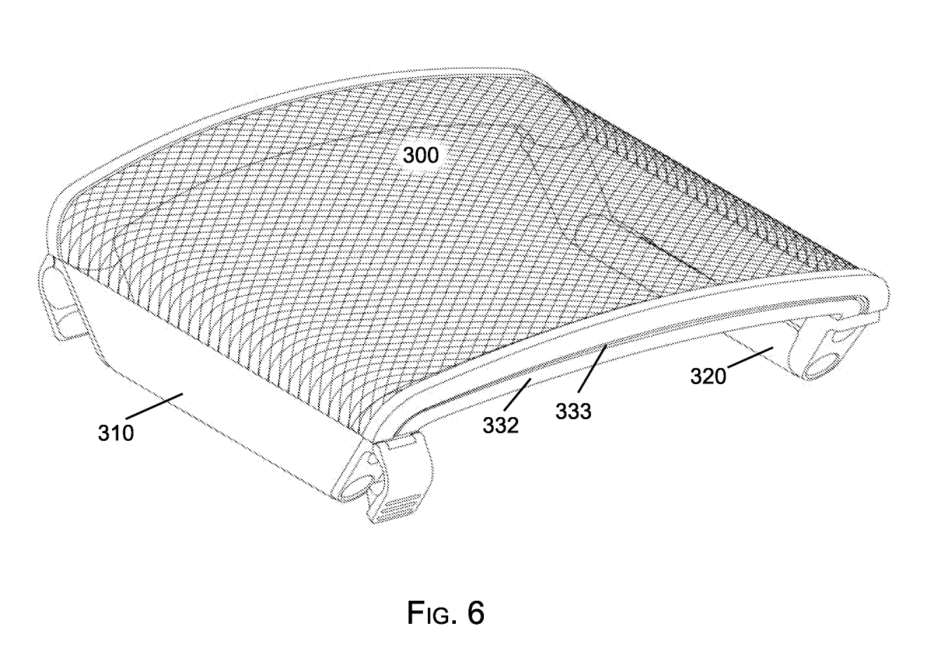

FIG. 6 is a front perspective view of a seating assembly. Seating surface 300 is an elastomeric fabric mesh. It extends across and attaches to the seat frame. By way of example, it is secured to side member 332 at its side region by channel 333. The front region 310 of seating surface 300 is operatively attached to the front member by a fastener, such as velcro or snaps. The rear region 320 of seating surface 300 is operatively attached to the rear member by a fastener. By attaching the seating surface at both the front and rear regions, the front and rear regions of the seating surface are caused to curve downward. This avoids the formation of firm edges at the front or rear of the seating surface and avoids compromising a user's circulation or comfort near the front underside of the thighs or near the rear of the buttocks.

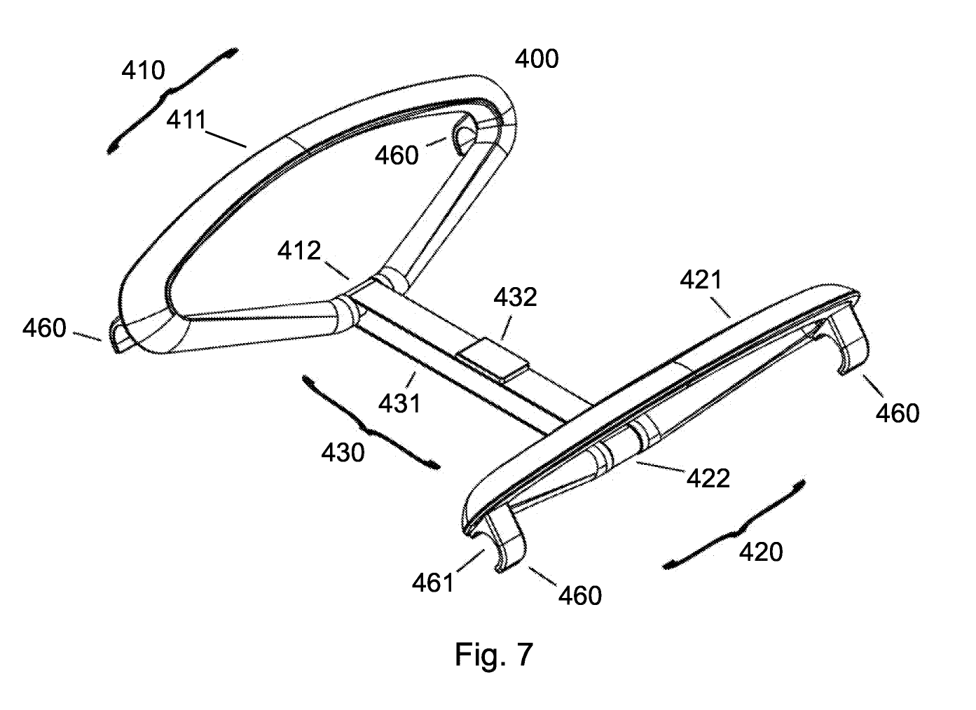

FIG. 7 is a front perspective view of another embodiment of a seat frame. Seat frame 400 includes left member 410, right member 420, and cross member 430. Left member 410 includes left upper region 411 and left recessed region 412. Right member 420 includes right upper region 421 and right recessed region 422. Cross member 430 includes strap 431 and ratchet 432. Clasps 460 are attached to the seat frame 400. Inner circumference of clasps (461) approximate the outer circumference of the bars of a wheelchair frame. Seat frame 400 is secured to a wheelchair frame by snapping clasps onto the bars of a wheelchair frame. A seating surface of elastomeric fabric can be secured the left upper region 411 and right upper region 421 extend across seat frame 400.

Left recessed region 412 is narrower in diameter than immediately adjacent portions of and left member 410. Right recessed region 422 is narrower in diameter than immediately adjacent portion of right member 420. The lengths of left recessed region 412 and right recessed region 422 are at last as long as the width of strap 431.

Ratchet 432 is loosened to adjust the length of strap 431 and, as a result, the length of cross member 430. Ratchet 432 is tightened to set the length of strap 431 and set the length of cross member 430. Wheelchair frame bars to which left member 410 and right member 420 are secured correspond to the axis of rotation for member, respectively. The weight of a person on a seating surface secured to the left member 410 and right member 420 exerts a force pulling left upper region 411 and right upper region 421 closer together. As a result of the axis of rotation, this corresponds to a force moving left recessed region 412 and right recessed region 422 farther apart. Cross member 430 limits the separation of the recessed regions based on the length of cross member. Thereby, the adjusted length of cross member 430 determines the distance between left upper region 411 and right upper region 421 and the corresponding tension across an elastomeric seating surface attached thereto.

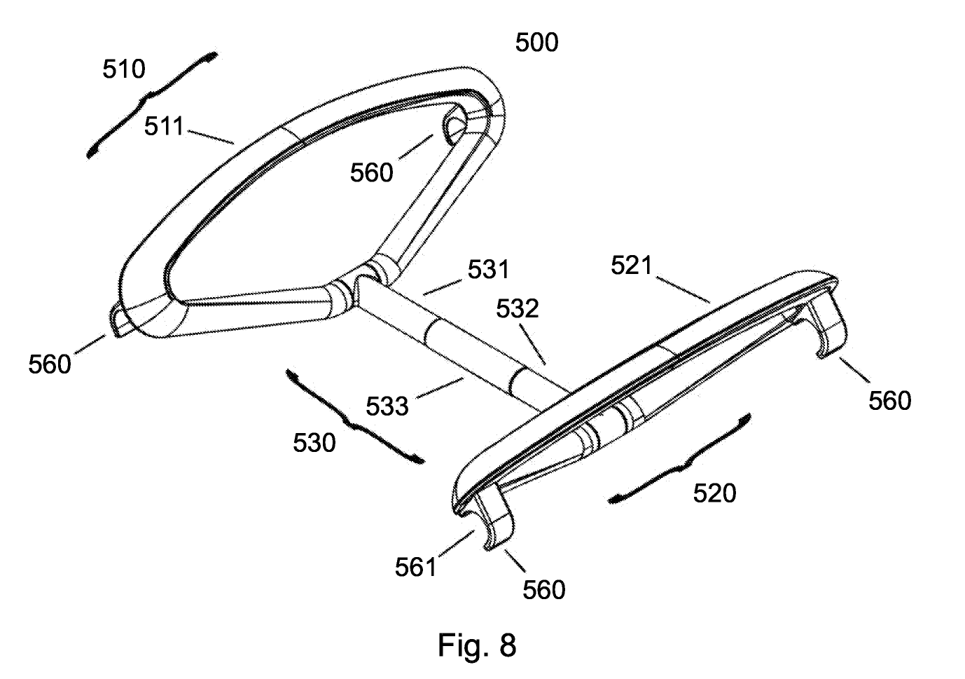

FIG. 8 is a front perspective view of still another embodiment of a seat frame. Seat frame 500 includes left frame member 510, right frame member 520 and cross member 530. Left frame member 510 includes upper region 511. Right frame member 520 includes upper region 521. A seating surface of elastomeric fabric can be secured to left upper region 511 and right upper region 521 and extend across seat frame 500.

Cross member 530 includes left threaded member 531, right threaded member 532 and center member 533. Left threaded member 531 is pivotally attached to left frame member 510. Right threaded member 532 is pivotally attached to right frame member 520.

Left threaded member 531 and right threaded member 532 are threaded in reverse orientation to each other. Center member 533 has a first end with a bore threaded to accept the thread of left threaded member 531 and a second end with a bore threaded to accept the thread of the right threaded member 532. Left threaded member 531 is threadedly attached to center member 533 at the first end. Right threaded member 532 is threadedly attached to center member 533 at second end. Clasps 560 are attached to the left frame member 510 and the right frame member 520. Inner circumference of clasps (561) approximates the outer circumference of bars of a wheelchair frame. Seat frame 500 is secured to a wheelchair frame by snapping clasps 560 onto bars of a wheelchair frame with the application of downward pressure.

Rotation of center member 533 in one direction is a tightening rotation causing left threaded member 531 and right threaded member 532 to move closer together. Rotation of center member 533 in the opposite direction is a loosening rotation causing left threaded member 531 and right threaded member 532 to move farther apart.

When the seat frame 500 has been secured to a wheelchair frame and a tightening rotation is applied to the center member 533, the reduction in distance between the left threaded member 531 and the right threaded member 532 is accompanied by the rotation of the left frame member 510 and the right frame member 520, the axis of rotation being the wheelchair frame bars to which each is secured with clasps 560. As a result of a tightening rotation, left upper region 511 and right upper region 521 are moved farther apart, thereby increasing the tension across an elastomeric seating surface secured thereto. Upon applying a loosening rotation to the center member 533, the increase in distance between the left threaded member 531 and the right threaded member 532 is accompanied by a reduction in the distance between left upper region 511 and right upper region 521 and a decrease in the tension across an elastomeric seating surface secured thereto.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

While a preferred form and various embodiments of the invention have been shown in the drawings and described, since variations in the preferred form will be apparent to those skilled in the art, the invention should not be construed as limited to the specific form shown and described, but instead as set forth in the following claims.

What is claimed is:

1. A seat assembly having a longitudinal axis and comprising:
a seating surface having front and rear regions; and
a means for supporting the seating surface such that there are no rigid points of contact at the front and rear regions of the seating surface.

2. A seat assembly as set forth in claim 1:
wherein the means for supporting the seating surface is a seat frame comprising two side members, a front member and a rear member and wherein said side members are positioned higher than the front and rear members,
wherein each side member has an inner periphery and an upper surface, and
wherein the seating surface is an elastomeric fabric extending between and secured to said side members.

3. A seat assembly as set forth in claim 2 further comprising a means of adjusting the tension across the seating surface.

4. A seat assembly as set forth in claim 3 wherein said means of adjusting the tension across the seating surface comprises a means of adjusting the width of the frame.

5. A seat assembly as set forth in claim 4 wherein the means of adjusting the width of the frame comprises a threaded means.

6. A seat assembly as set forth in claim 5 wherein said threaded means comprises:
said front member further comprising two front end members threadedly connected to a front threaded member, whereby a tightening rotation of the front threaded member will move the front end members closer and a loosening rotation of the front threaded member will move the front end members apart; and
said rear member further comprising two rear end members threadedly connected to a rear threaded member, whereby a tightening rotation of the rear threaded member will move the rear end members closer and a loosening rotation of the rear threaded member will move the rear end members apart.

7. A seat assembly as set forth in claim 5 wherein surface of said threaded member further comprises one or more flattened regions.

8. A seat assembly as set forth in claim 5 wherein each side member is pivotally attached to the front end members and the rear end members.

9. A seat assembly as set forth in claim 8 further comprising a layer of cushioning attached to the inner periphery of said side members.

10. A seat assembly as set forth in claim 9 further comprising a means of attaching said seat assembly to a wheelchair.

11. A seat assembly as set forth in claim 10 wherein said means of attaching said seat assembly to a wheelchair comprises:
a plurality of clasps pivotally attached to the seat frame; and
a plurality of flanges attached to the seat frame.

12. A seat assembly as set forth in claim 11 wherein said front and rear members define a horizontal plane and said side members are angled away from said longitudinal axis forming an obtuse angle with respect to said horizontal plane.

13. A seat assembly as set forth in claim 12 wherein said side members are curved convexly relative to said longitudinal axis.

14. A seat assembly as set forth in claim 13 wherein said seating surface is operatively secured to the front and rear members.

15. A seat assembly as set forth in claim 14 further comprising a layer of cushioning material attached to the inner periphery of said side members.

16. A seat assembly as set forth in claim 15 wherein said seating surface further comprises side regions, said side regions being fused to the cushioning material.

17. A seat assembly as set forth in claim 16 further comprising a layer of cushioning material attached to the upper surface of said side members.

18. A seat assembly as set forth in claim 14 further comprising a layer of cushioning material attached to the upper surface of said side members.

19. A seat assembly as set forth in claim 3 further comprising a layer of cushioning material attached to the inner periphery of said side members; and
wherein said seating surface is operatively secured to the front and rear members.

20. A seat assembly as set forth in claim 19 wherein said seating surface further comprises side regions, said side regions being fused to the cushioning material.

21. A seat assembly as set forth in claim 3 wherein each side member is pivotally attached to the front and rear members.

22. A seat assembly as set forth in claim 21 wherein said front and rear members define a horizontal plane and said side members are angled away from said longitudinal axis forming an obtuse angle with respect to said horizontal plane.

23. A seat assembly as set forth in claim 21 wherein said side members are curved convexly relative to said longitudinal axis.

24. A seat assembly as set forth in claim 23 further comprising a plurality of clasps pivotally attached to the seat frame.

25. A seat assembly having a longitudinal axis and comprising:
a seat frame comprising two side members, a front member and a rear member, wherein said side members are positioned higher than above the front and rear members, said side members having an inner periphery and an upper surface;
wherein each side member is pivotally attached to the front and rear members;
wherein said front and rear members define a horizontal plane and said side members are angled away from said longitudinal axis forming an obtuse angle with respect to said horizontal plane;
wherein said side members are curved convexly away from said horizontal plane
a layer of cushioning material attached to the inner periphery of said side members;
a seating surface having front and rear regions and comprised of an elastomeric fabric extending between and secured to said side members;
means of adjusting the tension across the seating surface comprised of a threaded member within each of the front and rear members; and
a means of attaching said seat assembly to a wheelchair comprising a plurality of clasps pivotally attached to the seat frame.

26. A wheelchair seat comprising:
a seat frame comprising two side members, a front member, and a rear member;
a seating surface extending between and operatively secured to said side members;
a means for adjusting tension across the seating surface, and
a means for securing said wheelchair seat to a wheelchair.

27. A wheelchair seat as set forth in claim 26,
wherein each side member is pivotally attached to the front and rear members;
wherein the seating surface is an elastomeric fabric;
wherein the means for adjusting tension across the seating surface is a threaded means located within the front and rear members; and
wherein the means for securing said seat to a wheelchair comprises a plurality of clasps pivotally attached to the seat frame.

28. A wheelchair comprising:
a frame with two or more side members, each having front and rear regions;
a seat comprising an elastomeric seating surface;
said seating surface extending between and secured to two side members; and
a means for adjusting the distance between said side members.

29. A wheelchair as set forth in claim 28,
wherein said adjusting means further comprises a first means for adjusting the distance between the front regions of said side members and a second means for adjusting the distance between the rear regions of said side members.

30. A seat assembly comprising:
a seat frame comprising a left member and a right member connected by a cross member;
a seating surface comprised of an elastomeric fabric extending between and secured to said left and right members; and
a means of attaching said seat assembly to a wheelchair comprising a plurality of clasps attached to the seat frame.

31. A seat assembly as set forth in claim 30, wherein said cross member is comprised of a strap and a means of adjusting the length of said strap;

32. A seat assembly as set forth in claim 30, wherein:
said cross member is further comprised of a center member with a first end threadedly attached to a left threaded member and a second end threadedly attached to a right threaded member; and
wherein said left threaded member is pivotally attached to said left member and said right threaded member is pivotally attached to said right member, whereby a tightening rotation of said center member will move the left and right threaded members closer and a loosening rotation will move the left and right threaded members apart.
